(19) United States
(12) Patent Application Publication
(10) Pub. No.: US 2020/0206848 A1
(43) Pub. Date: Jul. 2, 2020

(54) WELDING METHOD FOR MANUFACTURING A BI-COMPOSITIONAL SCREW

(71) Applicant: TAIWAN SHAN YIN INTERNATIONAL CO., LTD., Kaohsiung City (TW)

(72) Inventors: KOU-TSAIR SU, KAOHSIUNG CITY (TW); CHEN-LONG SU, KAOHSIUNG CITY (TW)

(21) Appl. No.: 16/235,005

(22) Filed: Dec. 28, 2018

(51) Int. Cl. B23K 31/02

(52) U.S. Cl. CPC B23K 31/02; B23K 2101/00

(57) ABSTRACT

A welding method for manufacturing a bi-compositional screw includes a preparing operation, a welding operation and a forming operation. The preparing operation prepares two raw blanks made of different materials and respectively processed to provide a front section and a rear section. The welding operation places the two sections on a positioning device to allow the two sections to meet closely at a joint along an axis, and then applies a welding device to weld the two sections at the joint in a circumferential direction when the two sections are rotated in the same rotational direction, thereby attaining a bi-compositional blank without causing waste extruded out of the joint. The forming operation forms a plurality of threads on the bi-compositional blank to forma bi-compositional screw. The method prevents the generation of air and pores inside the joint after welding, reduces processing costs, and ensures preferable processing quality.

### BACKGROUND OF THIS INVENTION

### 1. Field of this Invention

This invention relates to a welding method and relates particularly to a welding method for manufacturing a bi-compositional screw.

### 2. Description of the Related Art

A bi-compositional screw is made through welding two raw blanks which are provided with different materials into a bi-compositional blank and processing the hi-compositional blank to form a hi-compositional screw afterward. Generally, two materials of the bi-compositional blank are processed into a head portion and a drilling portion of the hi-compositional screw respectively. The drilling portion is usually made of a material with the higher strength in order to allow the drilling portion to screw into an object which is provided with larger hardness such as an iron plate effectively. On the other hand, the head portion is usually made of an antirust material such as stainless steel because the head portion is exposed to the air after the screwing operation is finished. Hence, the bi-compositional screw is provided with ti e antirust effect and the higher strength to attain a preferable screwing action.

Referring to FIG. 1 and FIG. 2, a conventional welding method 1 for manufacturing a hi-compositional screw 2B includes a preparing operation 11, a welding operation 12, a trimming operation 13, and a threading operation 14. The preparing operation 11 prepares two raw blanks 2 which are made of different materials and processes the two raw blanks 2 into a front section 21 and a rear section 22 respectively to provide the front section 21 and the rear section 22. The front section 21 further has a head 211 formed on an end of the front section 21 and a front end 212 formed on another end of the front section 21 opposite to the head 211 and defining a front welding surface 212A. The rear section 22 has a rear end 221 defining a rear welding surface 221A which faces the front welding surface 212A and a drill end 222 in opposition to the rear end 221. After that, the welding operation 12 restricts the head 211 and moves the rear section 22 toward a direction of the front section 21 to contact the front welding surface 212A with the rear welding surface 221A closely to form a joint C1, and thence rubs the front welding surface 212A against the rear welding surface 221A to increase the temperature of the joint C1, thereby melting the joint C1 caused by frictional heat to combine the front and rear sections 21,22 into a bi-compositional blank 2A. Afterward the trimming operation 13 removes unnecessary waste extruded out of the joint C1 where the front and rear welding surfaces 212A, 221A meet to provide a smooth peripheral face of the bi-compositional blank 2A. Finally, the threading operation 14 rolls a plurality of threads 21 on the bi-compositional blank 2A to form a bi-compositional screw 2B.

The conventional welding method 1 is executed by the front welding surface 212A against the rear welding surface 221A in order to integrate the front and rear sections 21,22 into the bi-compositional blank 2A. However, the rubbing procedure will cause the generation of air and pores inside the joint C1 to result in the reduced strength and quality of the bi-compositional blank 2A. Meanwhile, the rubbing procedure will cause that part of the front end 212 and the rear end 221 are pressed to form waste extruded outwards of the joint C1. The waste is carbide formed under a high temperature. Therefore, the waste needs t be softened before removing by a trimming device (not shown) in the trimming operation 13, or it will wear the trimming device. Thus, the processing costs are increased and additional procedures are required. Further, the processing difficulty is also increased and that requires to be improved.

### SUMMARY OF THIS INVENTION

The object of this invention is to provide a welding method for manufacturing a bi-compositional screw capable of reducing waste, ensuring preferable processing quality and decreasing processing costs.

The welding method of this invention includes a preparing operation, a welding operation and a forming operation. The preparing operation prepares two raw blanks made of different materials, then processes the raw blanks into a front section and a rear section respectively. The front section has a head, a shank extending outwards from the head, and a front end connected to the shank in opposition to the head and defining a front welding surface. The rear section has a rear end defining a rear welding surface which faces the front welding surface and a drill end opposite to the rear end. An outer diameter of the front end is equal to an outer diameter of the rear end. The welding operation equips a welding device and a positioning device disposed below the welding device, then aligns the front and rear sections on the positioning device along a same axis to contact the front welding surface and the rear welding surface closely at a joint, and thence rotates the front and rear sections in the same rotational direction to allow the welding device circumferentially welds the front and rear sections at the joint to integrate the front and rear sections into a bi-compositional blank. Therefore, the welding method prevents air and pores from generating inside the joint and prevents waste from being extruded out of the joint. Finally, the forming operation rolls a plurality of threads on the bi-compositional blank to form a bi-compositional screw. Thus, the processing procedures are simplified, the processing costs are reduced, and the preferable processing quality is attained.

Preferably, the welding operation heats directly without adding additional solder.

Preferably, in the welding operation, the joint where the front end and the rear end meet is circumferentially welded by the welding device to prevent waste from being extruded out of the joint after welding.

Preferably, in the preparing operation, both of the front welding surface and the rear welding surface are formed in a flat surface.

### BRIEF DESCRIPTION OF THE DRAWINGS

FIG. 1 is a block diagram showing the operations of a conventional welding method for manufacturing a bi-compositional screw in sequential order;

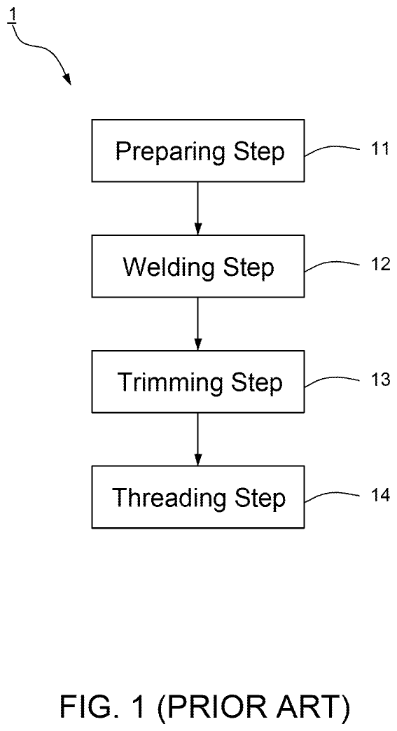

FIG. 2 is a schematic view in accordance with the conventional welding method;

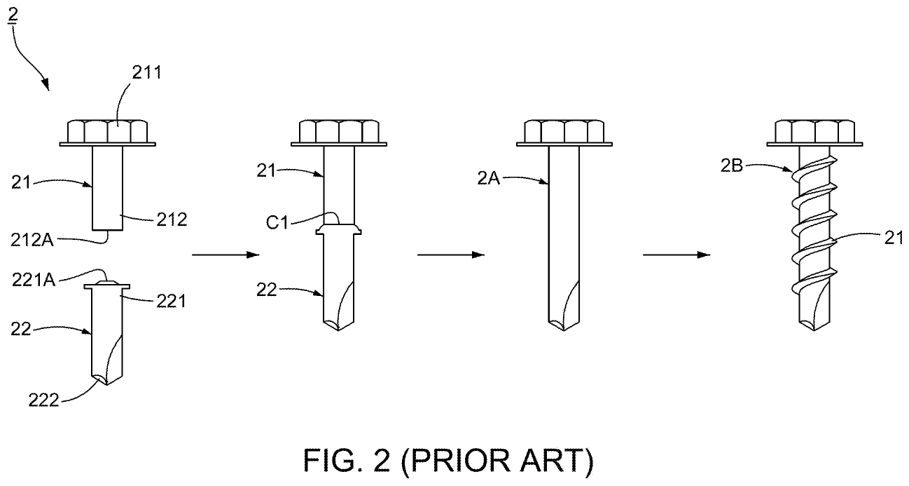

FIG. 3 is a block diagram showing the operations of a first preferred embodiment of this invention in sequential order;

FIG. 4 is a schematic view showing the front section and the rear section; and

FIG. 5 is a schematic view in accordance with the first preferred embodiment of this invention.

### DETAILED DESCRIPTION OF THE PREFERRED EMBODIMENTS

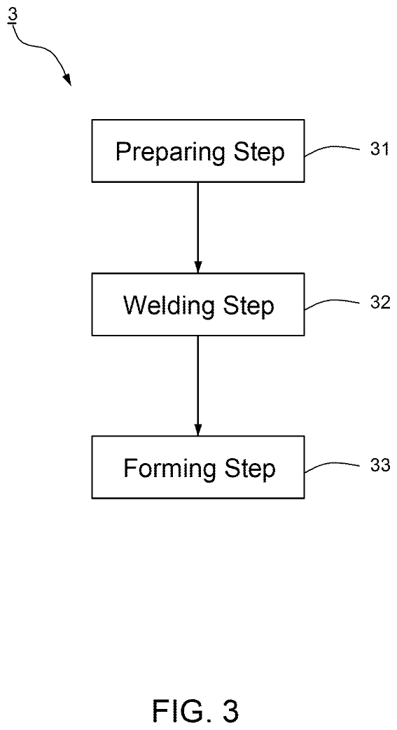

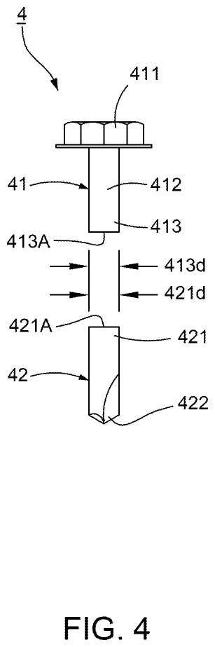

Referring to FIGS. 3 to 5, a welding method 3 for manufacturing a hi-compositional screw 4B of a first preferred embodiment of this invention includes a preparing operation 31, a welding operation 32, and a forming operation 33. The preparing operation 31 prepares two raw blanks 4 which are provided with different materials and processes the two raw blanks 4 respectively to form a front section 41 and a rear section 42, both of which are provided with smooth peripheral faces. The front section 41 has a head 411, a shank 412 extending outwards from the head 411, and a front end 413 with a front welding surface 413A formed on the front section 41 opposite to the head 411. The rear section 42 has a rear end 421 with a rear welding surface 421A formed on an end of the rear section 42 and a drill end 422 formed on another end of the rear section 42 opposite to the rear end 421. In this preferred embodiment, both of the front welding surface 413A and the rear welding surface 421A are formed in a flat surface. Meanwhile, an outer diameter 413d of the front end 413 is equal to an outer diameter 421d of the rear end 421, thereby providing a smooth peripheral face of the bi-compositional blank 4A thereafter and an equal circumference (not shown) from the shank 412 to the rear end 421. Further, the front section 41 can be made of a corrosion-resisting material such as stainless steel. On the other hand, the rear section 42 can be made of a material with higher hardness such as martensite or hardened materials.

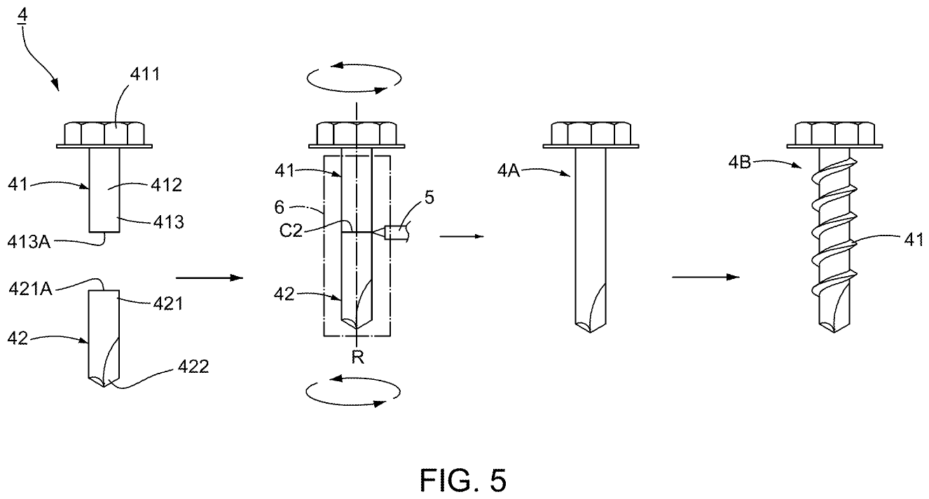

Referring to FIG. 3 and FIG. 5, after the preparing operation 31, the welding operation 32 prepares a welding device 5 and a positioning device 6 disposed below the welding device 5, then position the front section 41 and the rear section 42 on the positioning device 6 to allow the front welding surface 413A and the rear welding surface 421A to contact closely along an axis R and meet at a joint C2, and thence rotates the front section 41 and the rear section 42 in the same rotational direction driven by the positioning device 6 and simultaneously welds the front end 413 and the rear end 421 at the joint C2 in a circumferential direction executed by the welding device 5 which is disposed above the joint C2 where the front end 413 and the rear end 421 meet, thereby integrating the front section 41 and the rear section 42 to provide a bi-compositional blank 4A. Comparing with the robbing procedure of the conventional welding operation 12, the welding operation 32 of this invention is executed by direct heating without applying additional solder, the welding operation 32 can prevent air and pores from generating inside the joint C2 and prevents waste from being projected out of the joint C2 effectively.

Thus, no additional trimming procedure is required in the welding method 3 before executing the forming operation 33. After the welding operation 32, the forming operation 33 rolls a plurality of threads 41 on the bi-compositional blank 4A via a threading machine (not shown) to forma bi-compositional screw 4B. The drill end 422 can be processed into a drilling tail via a tail forming machine (not shown) according to needs. Hence, a succession of the operations 31, 32, 33 including the preparing, welding and forming attains the quick and smooth manufacturing operation of the bi-compositional screw 4B, simplifies the processing procedures effectively, reduces the processing costs, and ensures the preferable processing quality.

To sum up, the welding method of this invention includes the preparing operation, the welding operation and the forming operation. The preparing operation prepares and processes two raw blanks provided with different materials into the front section and rear section respectively. The welding operation circumferentially welds the front and rear sections which are placed in the same axis at the joint by the welding device during the rotation of the front and rear sections in the same rotational direction driven by the positioning device, thereby combining the front and rear sections into the bi-compositional blank. The forming operation forms a plurality of threads on the bi-compositional blank to produce the bi-compositional screw, thereby preventing the generation of air and pores inside the joint, avoiding causing additional waste extruded out of the joint, simplifying the processing procedures, reducing the processing costs, and ensuring the preferable processing quality.

While the embodiments of this invention are shown and described, it is understood that further variations and modifications may be made without departing from the scope of this invention.

What is claimed is:

1. A welding method for manufacturing a bi-compositional screw comprising:
a preparing operation which includes preparing two raw blanks made of different materials, said two raw blanks being processed respectively to form a front section and a rear section each provided with a smooth peripheral face, wherein said front section has a head, a shank extending outwards from said head, and a front end with a front welding surface formed opposite to said head, said rear section having a rear end with a rear welding surface facing said front welding surface and a drill end formed opposite to said rear end, an outer diameter of said front end being equal to an outer diameter of said rear end;
a welding operation which includes equipping a welding device and a positioning device located below said welding device, placing said front section and said rear section on said positioning device in position along a same axis so that said front welding surface of said front end and said rear welding surface of said rear end are in close contact at a joint, then rotating said front section and said rear section in a same rotational direction driven by said positioning device, and thence welding said front end and said rear end together at said joint in a circumferential direction by said welding device during the rotation of said, front section and said rear section so that said front section and said rear section are united to attain a bi-compositional blank; and
a forming operation which includes rolling a plurality of threads on said bi-compositional blank to form a bi-compositional screw.

2. The welding method according to claim 1, wherein said welding operation heats directly without adding additional solder.

3. The welding method according to claim 1, wherein in said welding operation, said joint where said front end and said rear end meet is circumferentially welded by said welding device to prevent waste from being extruded out of said joint after welding.

4. The welding method according to claim 1, wherein in said preparing operation, both of said front welding surface and said rear welding surface are formed in a flat surface.
